(19) United States
(12) Patent Application Publication
(10) Pub. No.: US 2010/0318421 A1
(43) Pub. Date: Dec. 16, 2010

(54) METHOD AND SYSTEM TO IDENTIFY THE CONTEXTUAL DATA THAT WAS USED TO PERFORM AN ADVERTISEMENT SELECTION

(76) Inventors: Gaelle Christine Martin-Cocher, Mississauga (CA); Suresh Chitturi, Plano, TX (US); Michal Andrzej Rybak, Bridgetown (BB)

Correspondence Address: Research in Motion Corp/SLW;Attn: Glenda Wolfe, Building 6, Brazos East, Suite 100, 5000 Riverside Drive, Irving, TX, 75039, US

(21) Appl. No.: 12/814,261

(22) Filed: Jun. 11, 2010

Related U.S. Application Data
(60) Provisional application No. 61/186,800, filed on Jun. 12, 2009.

(51) Int. Cl. G06Q 30/00

(52) U.S. Cl. 705/14.49

(57) ABSTRACT

Embodiments of a distributed ad-selection system and method for distributed ad selection are generally described herein.

### CROSS-REFERENCE TO RELATED APPLICATION

This non-provisional patent application claims the benefit of the filing date of U.S. Provisional Patent Application Ser. No. 61/186,800, filed Jun. 12, 2009, which is incorporated by reference herein in its entirety.

### TECHNICAL FIELD

Some embodiments pertain to the selection of advertisements (ads) for presentation to users of mobile devices. Some embodiments pertain to systems and devices that operate in accordance or compliance with one or more of the Open Mobile Alliance (OMA) standards or specifications. Some embodiments pertain to wireless networks and wireless communications.

### BACKGROUND

Advertisements may be delivered to users of computer systems and mobile wireless devices using mobile advertising systems. One example of a mobile advertising system is described in the Open Mobile Alliance (OMA) Mobile Advertising (MobAd) Architecture Specification.

### BRIEF DESCRIPTION OF THE DRAWINGS

FIG. 1 is a block diagram of an advertising system according to some embodiments.

FIG. 2 is a data flow diagram illustrating the use of a Contextual Data Identifier (ID) within an Ad request and a response message according to some embodiments.

FIG. 3 is an alternative data flow diagram illustrating the use of a Contextual Data Identifier (ID) within an Ad request according to some embodiments.

FIG. 4 is a flow chart of a method of constructing an Ad request message according to some embodiments.

FIG. 5 is a flow chart of a method of selecting an Ad according to some embodiments.

FIG. 6 is a flow chart of how the Ad Response message is processed and consumed or used by the Application according to some embodiments.

FIG. 7, which comprises FIGS. 7A, 7B, 7C and 7D, illustrates an AdContentData structure according to some embodiments.

FIGS. 8, 9 and 10, illustrate example deployment models according to some embodiments.

FIG. 11 is a table showing parameters for a ContextualData structure according to some embodiments.

FIG. 12 is a table showing parameters for an AdContentReference structure according to some embodiments.

FIG. 13, which comprises FIGS. 13A and 13B, shows parameters for an AdContentData structure according to some embodiments.

FIG. 14, which comprises FIGS. 14A and 14B, shows parameters for an Ad Response message according to some embodiments.

FIGS. 15, 16, 17, 18, and 19 illustrate examples of Ad placements according to some embodiments.

### DETAILED DESCRIPTION

The following description and the drawings provide various embodiments. Other embodiments may incorporate structural, logical, electrical, process, and other changes. Examples merely typify possible variations. Individual components and functions are optional unless explicitly required, and the sequence of operations may vary. Portions and features of some embodiments may be included in, or substituted for those of other embodiments.

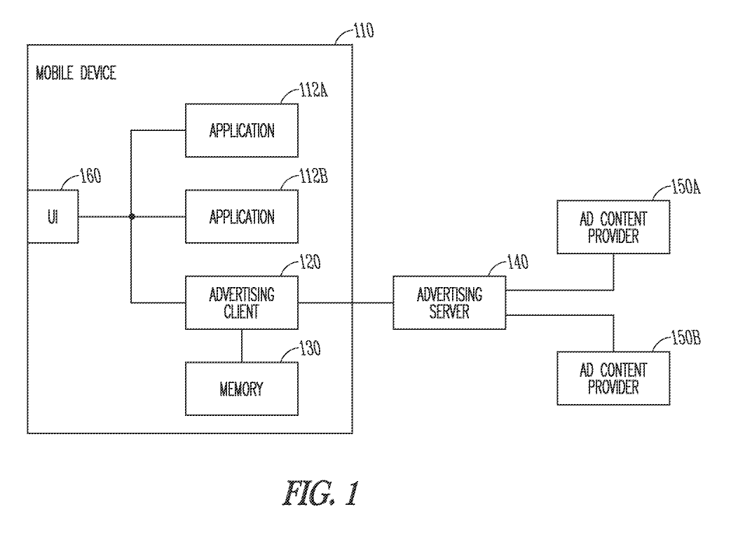

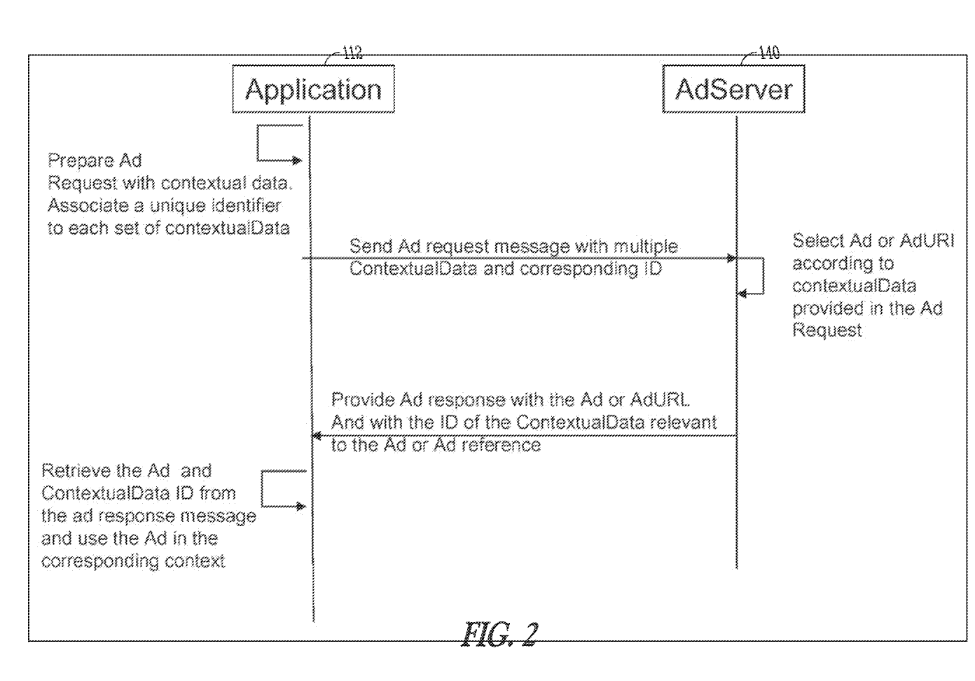

Example Operating Environment. FIG. 1 shows a block diagram illustrating logical components within a system for facilitating mobile advertisement. A mobile device 110 is adapted to consume or create content through an application 112 and to perform other related functions. When used herein, a mobile device is a general term that may include cellular telephones, mobile devices, pagers, laptop computers or other devices.

In the embodiment of FIG. 1, a mobile device 110 comprises one or more applications 112A and 112B, and an advertising client 120 which may also be referred to as an advertising “engine” or Ad Engine. The use of applications 112 are merely meant for simplification and in practice multiple applications may be installed on the mobile device 110.

Applications 112A and 112B (referred to throughout the document as 112 for either a single application or multiple applications) represent applications that utilize advertisements. Examples may include an advertisement enabled email application in which advertisements are inserted into/above email messages, a web browser showing web pages into/above which advertisements can be inserted, instant messaging applications into/above which advertisements can be inserted, video or multimedia players which can have advertisements therein, and so on.

In the embodiment of FIG. 1, an advertising client 120 communicates with application 112 over an application program interface (API) and can further communicate with an advertising server 140 (also referred to as an Ad server) which is configured on a network device such as server hardware (e.g., a computer with a processing unit, communication portion and storage/memory). Advertising client 120 may further communicate with memory on a mobile device 110. Such memory is shown as memory 130 in FIG. 1. Such communication may for example proceed through a processor and a bus.

Advertising server 140 may be responsible for selecting and/or providing advertisements from advertising content providers to appropriate devices. In one embodiment, the advertising server 140 may also be responsible for delivering advertisements to mobile device 110. As will be appreciated this may be done through a pull system in which an advertising client 120 requests ads from advertising server 140. Alternatively, this may be done on a push system in which advertising server 140 decides that mobile device 110 should receive certain ads and pushes these ads to advertising client 120.

Furthermore, advertisements may be pushed on the fly. In other words, the advertisements may be obtained from advertising server 140 as they are requested by application 112. In alternative configurations the advertising server 140 may provide ads to mobile device 110 which are stored within memory 130 of the mobile device. This may facilitate the transfer of ads when network conditions are suitable for data transfer. Such network conditions may include a low cost period such as in the middle of the night or when the mobile device 110 is connected to a network through means such as a USB connection through a computer or through a wireless local area network (WLAN) such as WiFi or WiMAX.

An ad content provider, as illustrated by ad content providers 150A, 150B in FIG. 1, may be an ad content provider with an established business relationship with advertising server 140.

In one embodiment, an application 112 or an advertising client 120 sends a request for an advertisement (also referred to as an Ad request) to an Ad server 140. The Ad request may include parameters for contextual information relevant to the application 112 characteristics. In response to the Ad request, the Ad server 140 may provide an Ad with some metadata corresponding to the advertisement content/data. The structure of the response message (also referred to as an Ad response) maybe composed of the payload of the Ad with some metadata related to characteristics of the Ad.

In one embodiment, an application 112 sends an Ad request with contextual data or multiple contextual data sets and in return receives an Ad with an indication of the level of relevance of the Ad compare to the criteria that was passed in the request. However, in previous systems the application 112 receiving an Ad is not easily able to correlate the Ad response to the relevant contextual data that was sent in the Ad request.

For example, when an Ad request is sent for two advertisements to be displayed on a Web page containing ten news articles, the Ad request may also contain ten contextual data elements. Each one of the ten contextual data elements may be relevant to one of the articles. According to the present disclosure, when the Ad Server selects and returns the two ads, the Ad server may also indicate to which contextual data or contextual data set each of the two Ads corresponds. If this identification is not performed, the Application 112 receiving the two Ads with an indication that the two Ads are relevant may not be able to determine which of the ten articles the two ads should be place beside. This may result in a bad user experience if, for example, an Ad about a sporting event is placed near an article about music or vice versa.

In another embodiment, an application may request multiple Ads, all being related to a single context. For instance, three ads could be inserted in a content related to car racing. The response may contain three ads, two of the three being related to the context and one being a default advertisement. In this embodiment the two targeted ads should be used in the most visible places. To avoid having a bad user experience it would be useful to indicate that the default Ad does not relate to the context.

Under a traditional model of mobile advertising, mobile advertising server 140 may provide an ad to advertising client 120. However, Application 112 may not refine or discard the Ad selection performed by the Ad server 140 if the Ad is not appropriately targeted for the Application 112. In the OMA MobAd context, the current Ad message response provides very minimal details on the parameters associated with an Ad or an Ad Reference. An application receiving such Ad or Ad reference may have to perform extra processing in order to understand if the Ad can be used. To more effectively utilize the Ad (e.g., select best position for the Ad within content page), the structure of the Ad response message which describes the Ad (e.g., the type of media embedded and associated attributes such as display size, time, and validity, among others), needs improvement.

The present disclosure therefore provides for assigning a Contextual Data Identifier (ID) to contextual data parameters in an Ad request and an Ad response message. The present disclosure also provides for a standard data structure for an Ad response message in the form of an AdContentData or an AdContentReference. In some embodiments, advertising client 120 and/or advertising server 140 may operate with applications 112 in accordance or compliance with one or more of the standards or specifications of the Open Mobile Alliance (http://www.openmobilealliance.org).

Contextual Data Identifier. FIG. 2 is an example data flow diagram illustrating the use of a Contextual Data Identifier (ID) within an Ad request and a response message, and the use of the ID during Ad selection at the AdServer and the Application. Contextual data are information related to a context. Example of context can be the topic of a content (e.g. sport), the device capabilities, the user location, the type of application or other service characteristic. As shown in FIG. 2, the application 112 may be responsible for determining or computing the contextual data that is relevant for the content/service/application or user and associates a unique identifier to the ContextualData set. The contextual data may be comprised of one or more (e.g., a plurality of) sets of contextual data where each set corresponds to a different context and includes an identifier such as the aforementioned Contextual Data ID. The contextual data set may be constructed in XML and may be an element with multiple attributes corresponding to multiple contextual data information and there might be a series of contextual data element corresponding to multiple contexts.

For example, the contextual data may be structure in the following manner:
<User Profle>—indicating the user profile
<Age> . . . </Age>—the age of the user
<Interests> . . . </Interests>—interests or hobbies of the user

### </UserProfile>

<Location> . . . </Location>—the current location of the user
<Theme> . . . <Theme>—the theme or category of the application
The attributes that are used in the above example are not meant to be limited but may contain other attributes as those skilled in art would understand.

In an alternate embodiment, the contextual data set can be structured in a format other than XML (e.g., in binary format). The Application 112 making the Ad Request may reside on a computer connected to a wireless network or may reside on a wireless device.

Upon receiving the Ad request from the Application 112, the Ad server 140 performs the Ad selection based on the Ad request. In one embodiment, when the Ad selection is performed by the Ad Server 140, an Ad is found that matches one or multiple contextual data sets provided within the request. The Ad Server provides as part of the response, the Ad or Ad reference, and the contextual data identifier(s) that is relevant to (and/or was used to select) that Ad or Ad reference. Inclusion of the contextual data identifier(s) in the response enables the Application receiving the Ad and the contextual data identifier(s) to make a correlation between the Ad provided in the response with the context provided in the request using the contextual data identifier(s). This way, the application can use the Ad within the appropriate context corresponding to the identifier(s) (e.g. the sport Ad near the sport article).

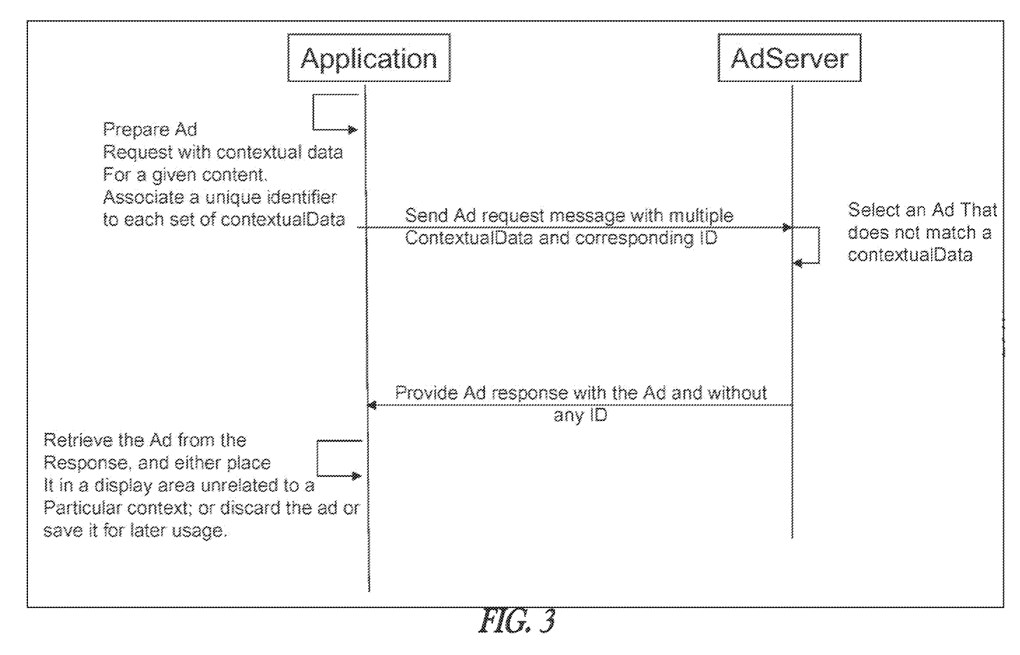

In another embodiment, the Ad selection is performed by the Ad server 140, but no Ad is found that matches the criteria established in the contextual data sets provided within the request. In this case the response may contain the Ad(s) or Ad reference(s) although the response omits the contextual data identifier(s). Alternatively, if a default Ad is return the response may contain an indication (e.g., metadata such as keyword(s), etc. corresponding to the indicated context in the request) that this advertisement was not selected according to the contextual data. This enables the Application receiving the Ad (i.e. with no contextual data identifier) to determine that the Ad is not directly relevant to one of the provided context and will act accordingly (e.g. either place the ad if desired, or discard it if it deems inappropriate). This embodiment is shown in FIG. 3. In the example embodiments shown in FIG. 3, the Application may be an application residing on a wireless network or the Application may reside on a mobile device. It should be noted that the response from the Ad Server could contains multiple Ads or references to Ads, some with identifiers or some without identifiers.

Ad Response Data Structure. In addition, the present disclosure describes an enhancement to the current Ad message response structure by adding specific parameters to the AdContentData structure and introducing a new AdContentReference structure.

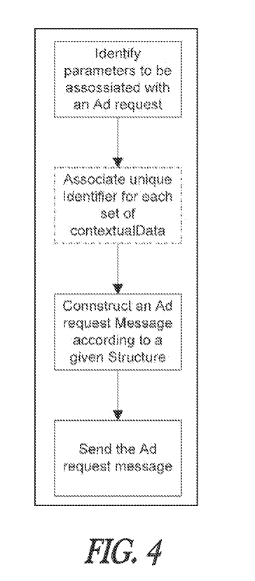

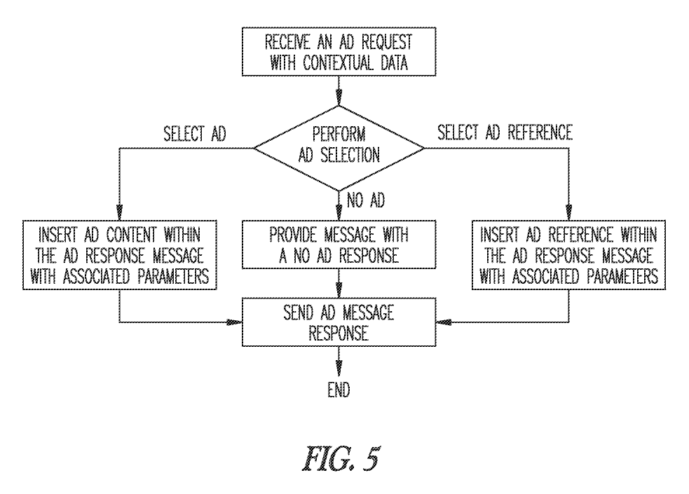

FIG. 4 is a flow chart of a method of constructing an Ad request message. The method comprises identifying parameters to be associated with an Ad request, associating a unique identifier with each set of contextual data, constructing an Ad Request message and sending the Ad request.

FIG. 5 is a flow chart of a method of selecting an Ad according to some embodiments. As shown in the FIG. 5, the Ad Server 140 performs the Ad selection based on one or more Ad request parameters (such as the contextual data) or other information the Ad server may know about the application. The Ad Server then constructs and sends the Ad response message which may include one of the following:

1) An Ad Response containing the AdContentData (i.e. the actual content representing the Ad) and associated parameters
2) An Ad Response containing the AdContentReference (i.e. a reference or URI to the actual content representing the Ad) and associated parameters
3) An Ad Response with no Ad content (e.g. implies that no matching Ad(s) was found)

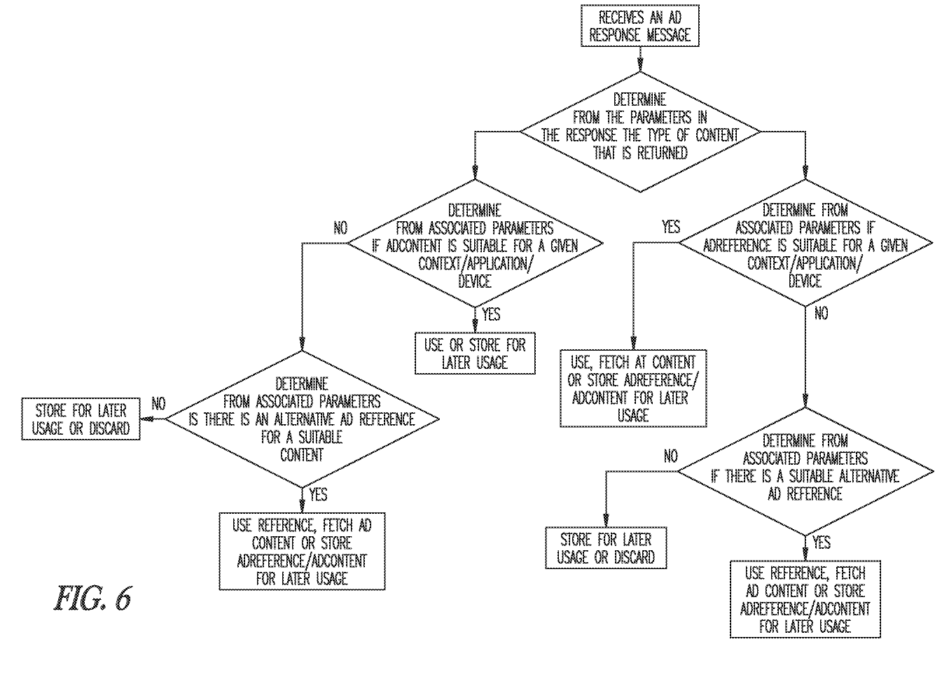

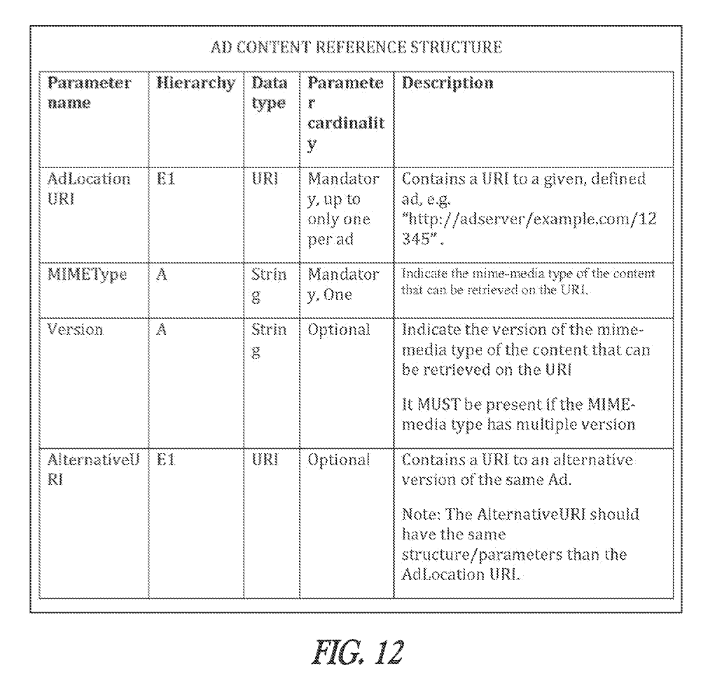

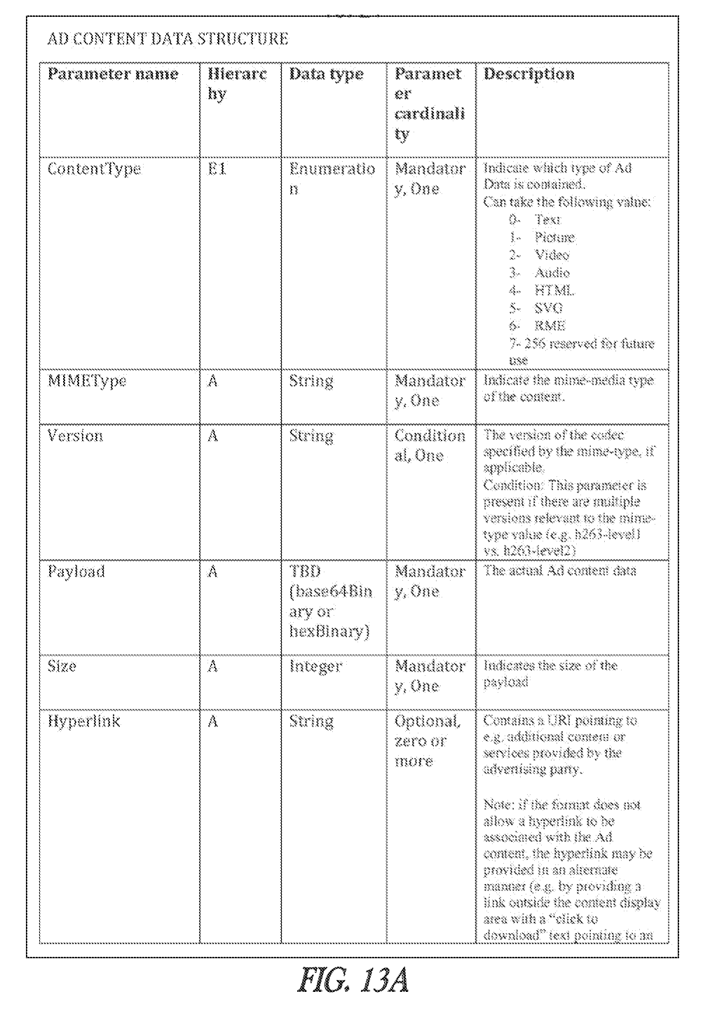

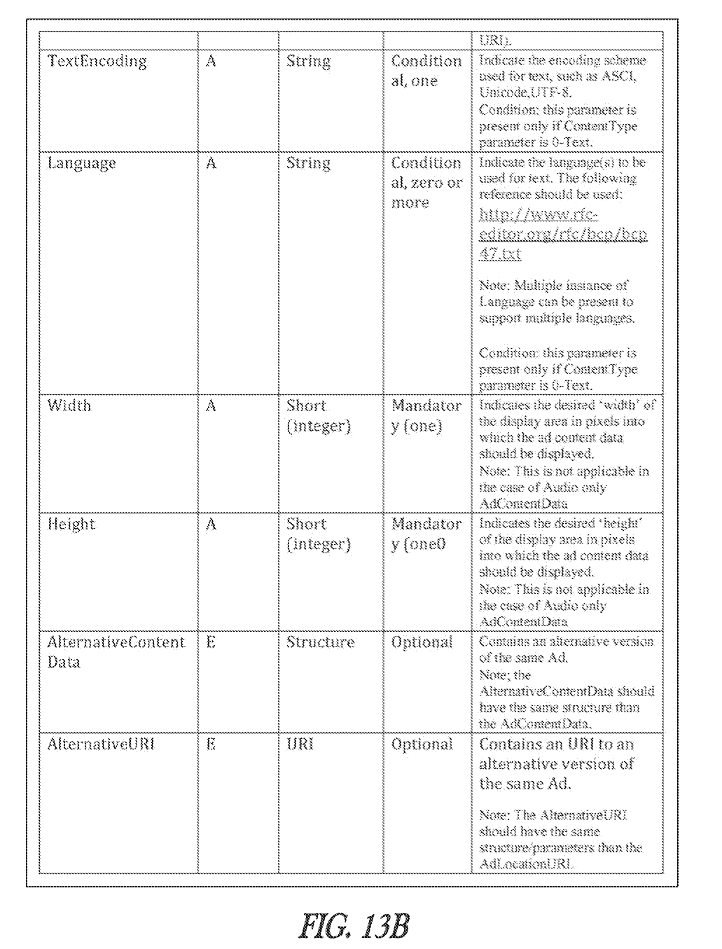

FIG. 6 is a flow chart of how the Ad Response message is processed and consumed or used (e.g. passing the Ad to another application in certain cases that may consume the Ad) by the Application. As shown in the FIG. 6, the Application retrieves reference to an Ad or the Ad Content itself and associated parameters from the Ad response message prior to consuming/using it. Based on the parameters associated with the Ad Reference or the Ad Content the application may decide to fetch or directly use the Ad embedded in the Ad response message. The reference to an Ad, and the Ad Content data may be organized in a structure. For instance in XML the AdContentData (shown in FIG. 13) and the AdContentReference (shown in FIG. 12) may be defined as two logical structures.

As further described in the next section of this detailed description, the structure for the AdContentData (shown in FIG. 13) provides a set of basic parameters that are generic in nature, i.e. ContentType and MimeType, AlternativeURI, AlternativeContentData and Version; followed by more detailed parameters (or attributes). As detailed in the next section, some of the detail parameters (e.g. language, encoding) are applicable only to a particular content type/MIMEtype (e.g. Text content). The ContentType parameters is used to describe the type of Ads such as image, video, text or the like. The MimeType parameters is used to refers to a particular codec associated with the content type. AlternativeURI and AlternativeContentData are parameters allowing to provide an alternative Ads; for instance in the case there was an error (e.g. the Ad is corrupted, or the device is unable to render for unknown reasons, among others) while retrieving the initial Ad.

In addition to the AdContentData structure, the next section also describes a structure for the AdContentReference (shown in FIG. 12) that contains an AdLocationURI which may be used to for retrieving the Ad. Note that parameters such as MIMEType and Version are also present in the AdContentReference structure similar to the AdContentData structure. Further, the AdContentReference structure contains an AlternativeURI parameter which may be used to retrieve an alternate or fallback version of the same Advertisement. This is typically used in the case wherein the original Ad cannot be rendered or supported by the device. For instance a text based version of the image Ad or Video Ad may be obtained by the AlternateURI.

Alternatively to a structure providing various parameters associated with a URI as in the case of AdContentReference, it may also be is possible to address all the parameters in the URI, by utilizing the addressing scheme provided by RESTful web services. For example, the AdLocationURI may be represented as follows: http://adserver/example.com/video/h263/level1/AdVideo.swf wherein:

/video is equivalent to the ContentType parameter

/H263 is equivalent to the MimeType parameter
/level1 is equivalent to the Version parameter
/AdVideo.swf is equivalent to the Payload parameter

And similarly, the AlternativeURI may be represented as follows (which corresponds to an alternate version of the same Ad): http://adserver/example.com/image/jpeg/2/AdImage.jpeg wherein:
/image is equivalent to the ContentType parameter
/jpeg is equivalent to the MIMEType parameter
/2 is equivalent to the Version parameter
/AdImage.jpeg is equivalent to the Payload parameter

In an alternate embodiment, the notion of alternative version of Ads could be authored based on the user/device locales. For example,

BlackBerry Ad in English for US locale

BlackBerry Ad in Japanese for JP locale

BlackBerry Ad in French for FR locale

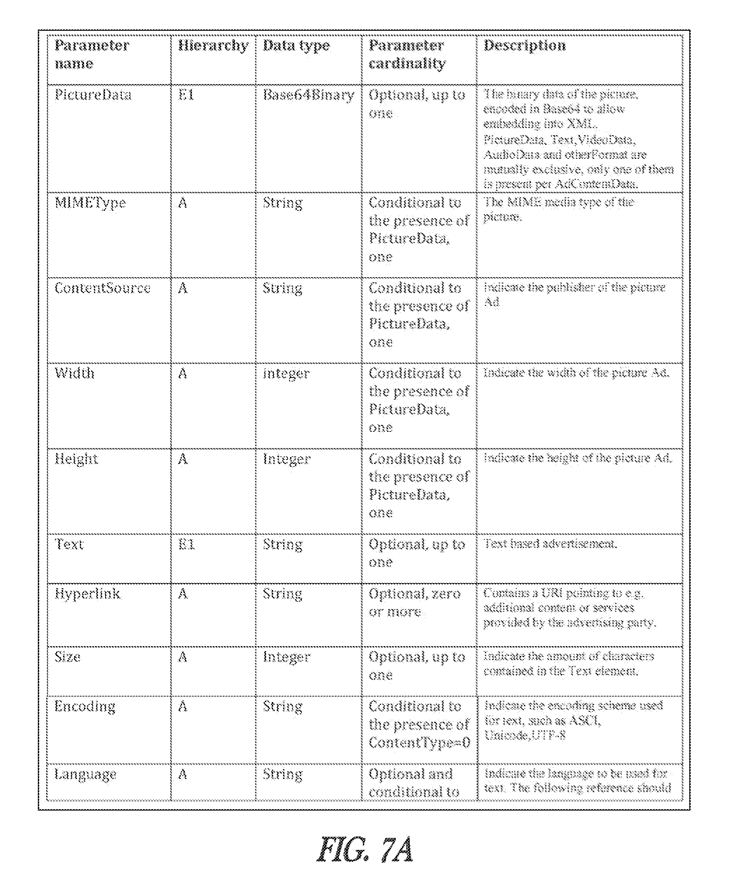

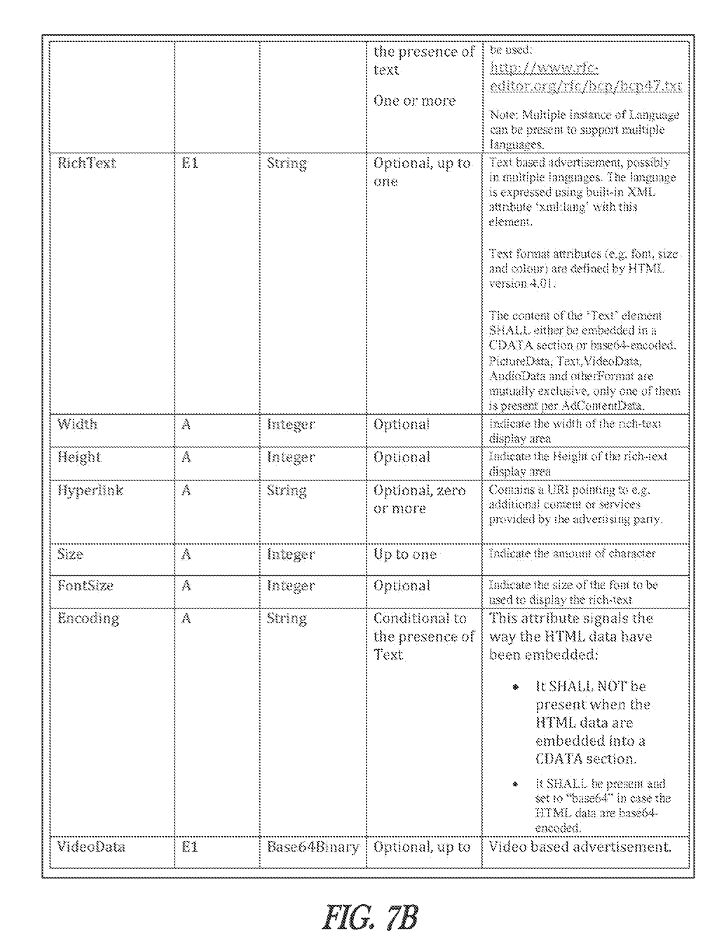

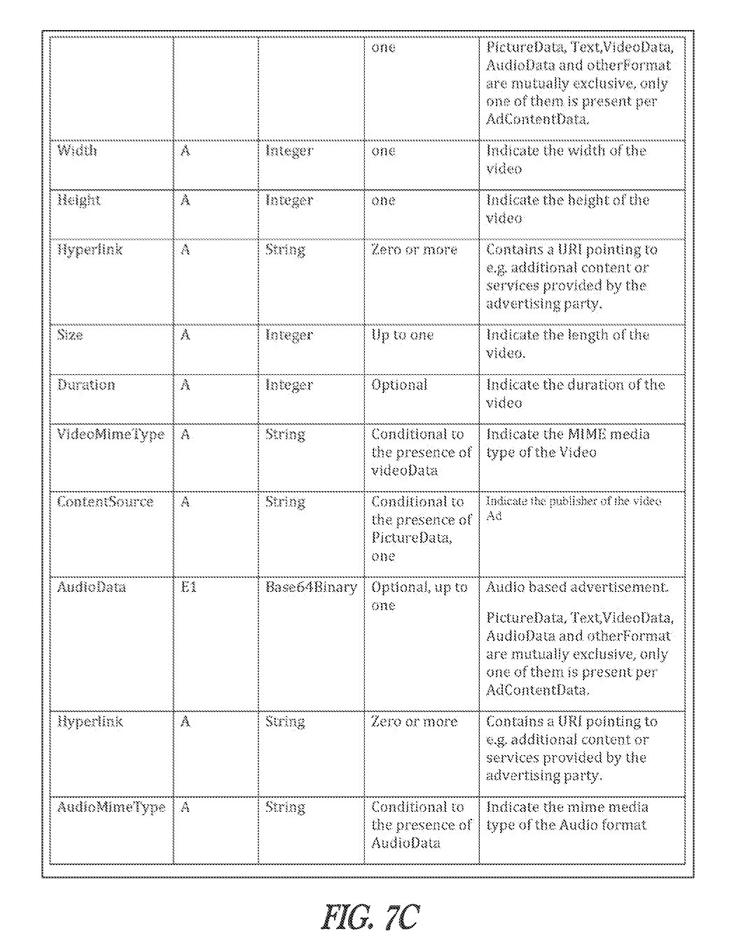

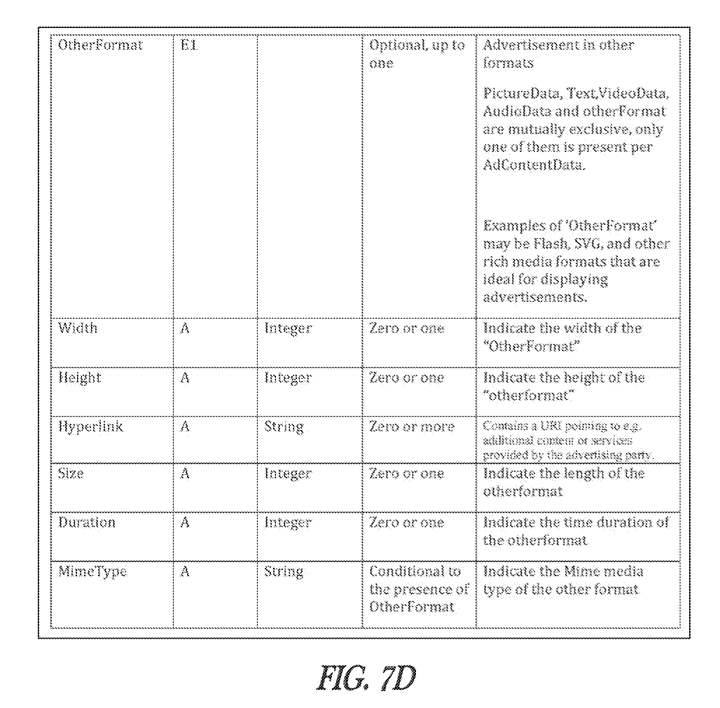

In another embodiment, the structure for the AdContentData can be represented as described in the table shown in FIG. 7, which is comprised of FIGS. 7A-7D. This structure does not provide generic parameters but describes all possible payload formats (e.g. PictureData, Text, RichText, VideoData, AudioData, OtherFormat) with their specific attributes. All of the payloads described are mutually exclusive. In the table shown in FIG. 7, the Hierarchy column shows an exemplary hierarchy of the element with their respective attributes (i.e. ‘E’ refers to element and ‘A’ refers to attribute).

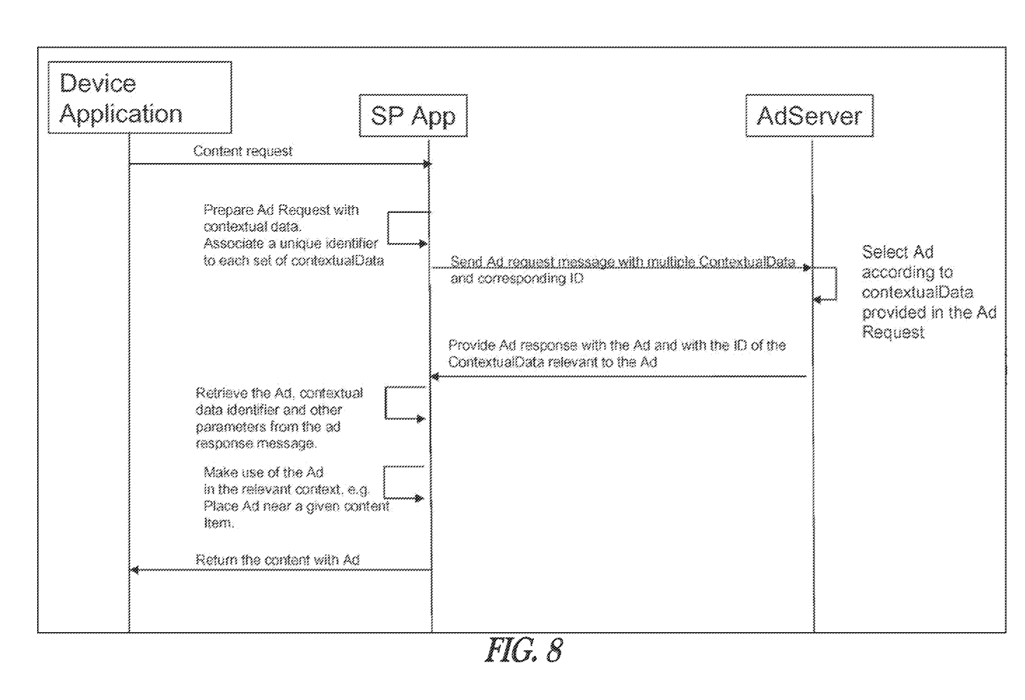

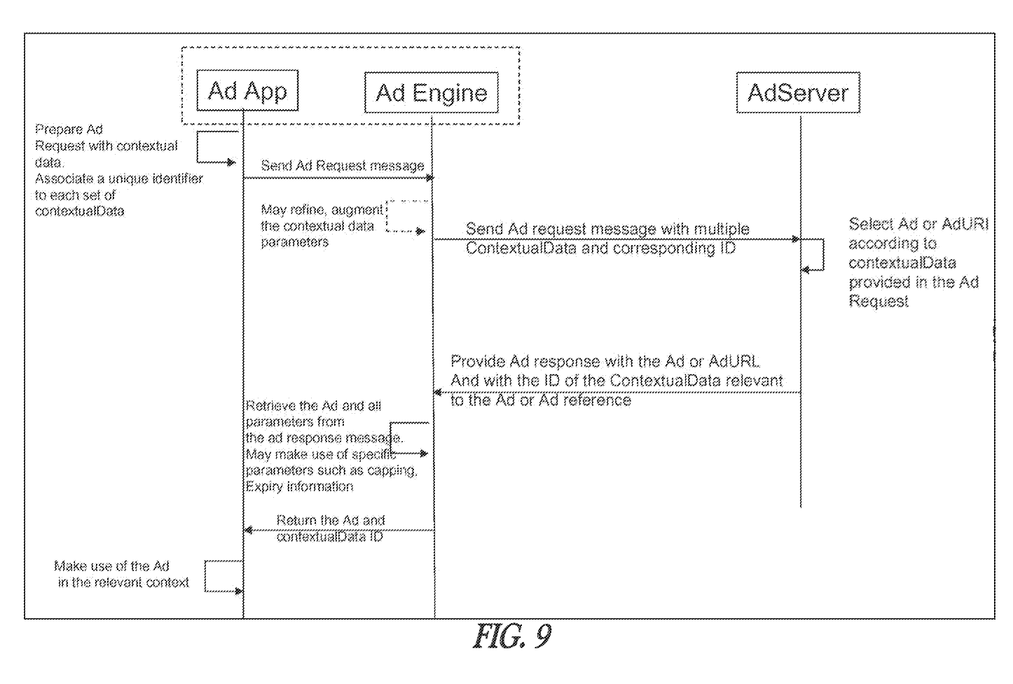

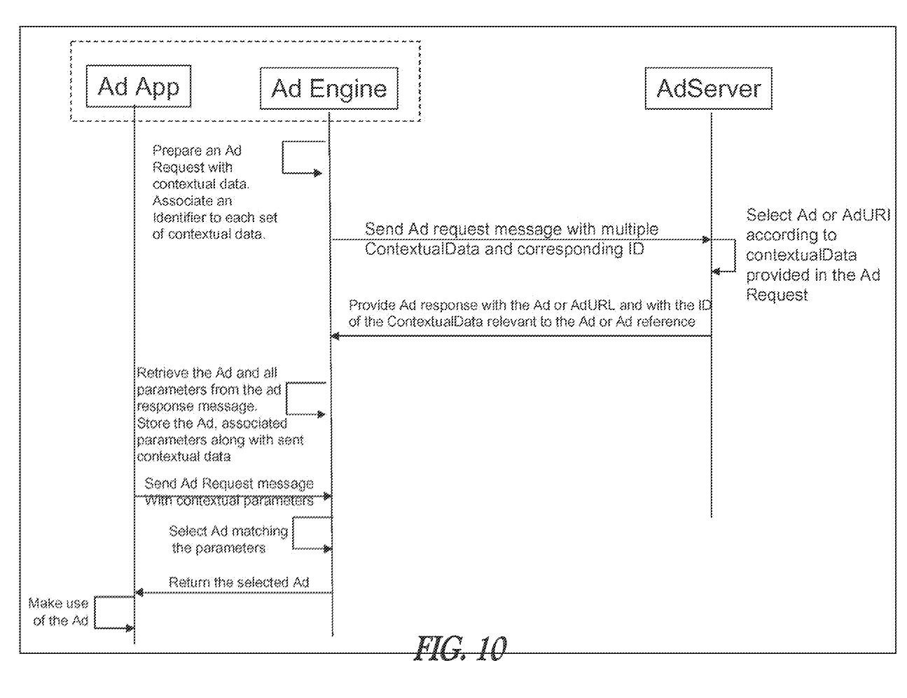

Example Implementations. FIGS. 8, 9 and 10, illustrate example deployment models for embodiments of the present disclosure. In the example shown in FIG. 8, the Application preparing the Ad request resides in a network (such as an OMA MobAd SP App). In the examples shown in FIGS. 9 and 10, the Application preparing the Ad Request resides on the wireless device and may comprise an Application component (OMA MobAd Ad App) and an Ad Engine component (such as an OMA MobAd Ad Engine).

In one embodiment, a MobAd SP App is an Ad enabled network Application that is executing on a server device or hardware within the Service Provider environment (e.g.: MMSC or SP-portal) and interacts with the MobAd Enabler for providing Ads as part of its service (e.g. requesting Ads, providing metrics data).

In one embodiment, a MobAd Ad Engine is an application implementing MobAd Enabler functions and running on the Device. The Ad Engine interacts with Ad App and Ad Server. The Ad Engine may be a device-resident group of functionalities potentially organized in logical modules. The Ad Engine may interact with different Ad Apps and may perform functions such as: obtaining appropriate ads from MobAd Ad Server, selecting ads from a local storage, providing metrics related feedback to MobAd Ad Server, filtering and matching information as well as potentially scanning content.

In one embodiment, a MobAd Ad App may be an application running on the device which interacts with the Ad Engine in order to present Ads to the user.

SP App, Ad Engine, and Ad App are further described in the Open Mobile Alliance Mobile Advertising (MobAd) Architecture Specification and Core Technical Specification available at http://www.openmobilealliance.org.

The FIGS. 8, 9, and 10 illustrate how an application constructs and sends an Ad Request based on a given structure. The structure may include the associated contextual data (and identifier) to be used as the criteria for Ad selection.

As described and shown in FIG. 8, the SP App resides on the network and serves Ad/content to mobile devices according to embodiments of the disclosure.

As described and shown in FIG. 9, the Ad App and Ad Engine reside on a mobile device and the Ad App prepares an Ad Request according to embodiments of the present disclosure.

As described and shown in FIG. 10, the Ad App and Ad Engine reside on a mobile device and the Ad Engine prepares an Ad Request according to embodiments of the disclosure.

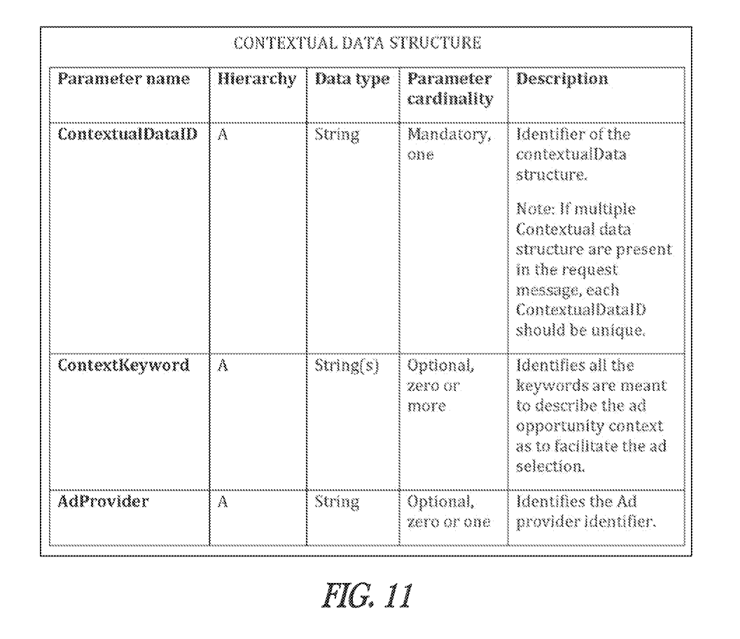

FIG. 11 is a table showing parameters for a ContextualData structure according to some embodiments.

FIG. 12 is a table showing parameters for an AdContentReference structure according to some embodiments.

FIG. 13, which comprises FIGS. 13A and 13B, is a table showing parameters for an AdContentData structure according to some embodiments.

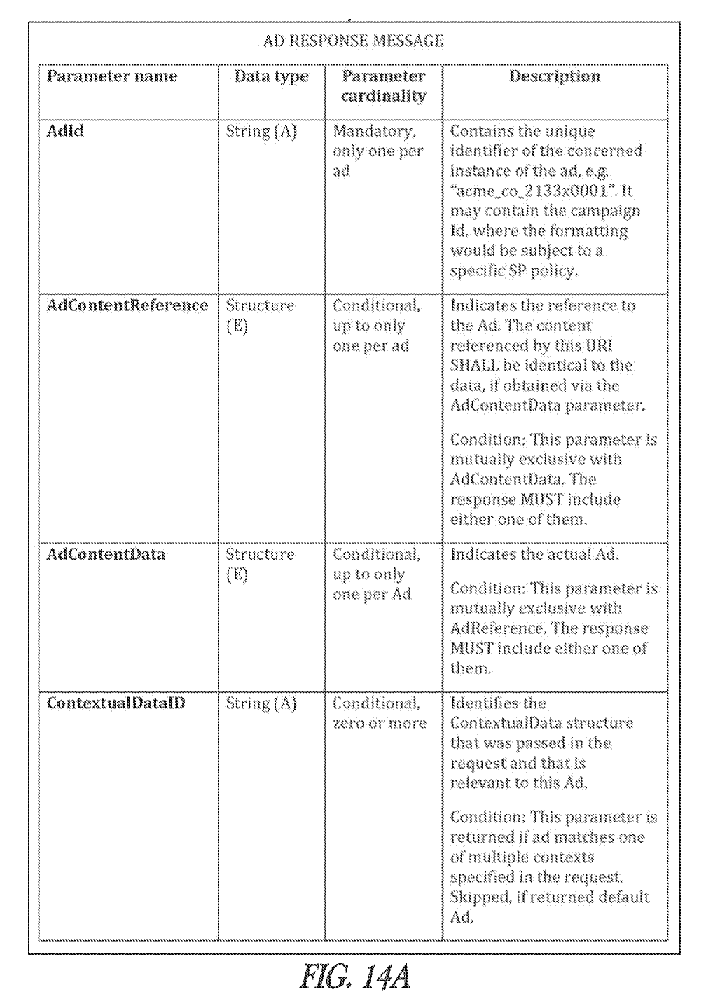

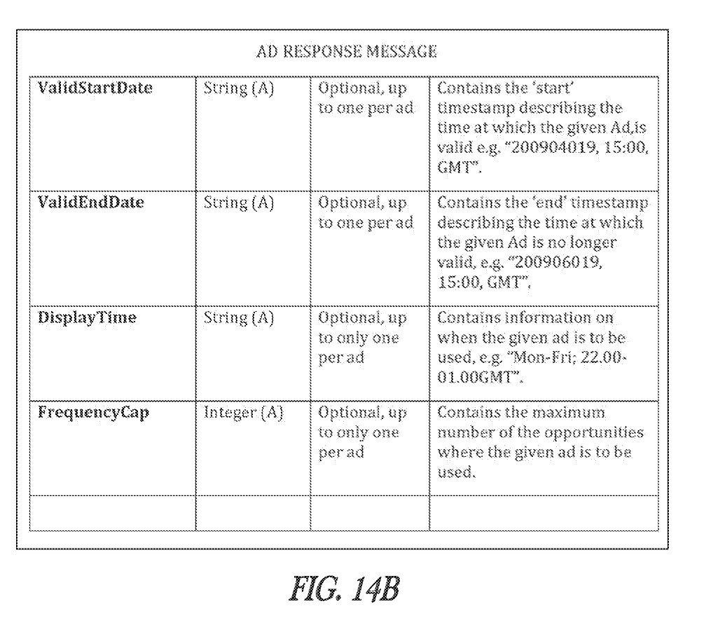

FIG. 14, which comprises FIGS. 14A and 14B, is a table showing parameters for an Ad Response message according to some embodiments. The example message shown in FIG. 14 includes parameters identifying the AdContentReference structure of FIG. 12, the AdContentData structure of FIG. 13, and the ContextualDataID parameter corresponding to the ContextualDataID of the ContextualData Structure (which is included in an ad request) of FIG. 11.

Example Ad Placements. FIGS. 15, 16, 17, 18, and 19 illustrate examples of Ad placements according to some embodiments.

In the example shown in FIG. 15, an Ad request may be made for three Ads to be placed in Ad Spot #1, Ad Spot #2 and Ad Spot #3. An example Ad request may contain the following parameters:

Number of Ads=3

Context 1: airline, airfares, luxury travel

Context 2: Sicily, cuisine, vacation hot spots

Context 3: Canada, Muskoka, lake resort, Lake Rosseau

In this example, Ad Spot #1 can correspond to all Contexts. Ad Spot #2 can correspond to Context 1 and Context 2. Ad Spot #3 can correspond to Context 2 and Context 3.

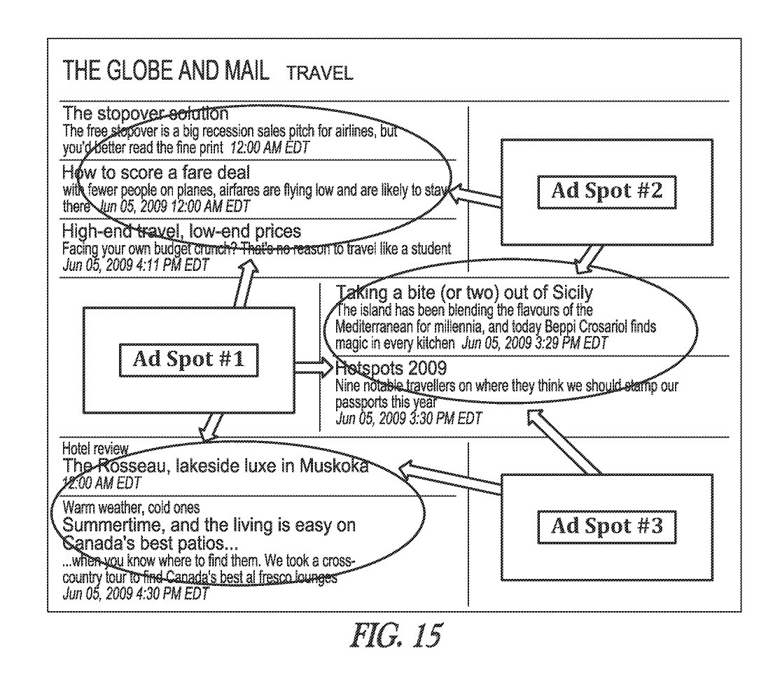

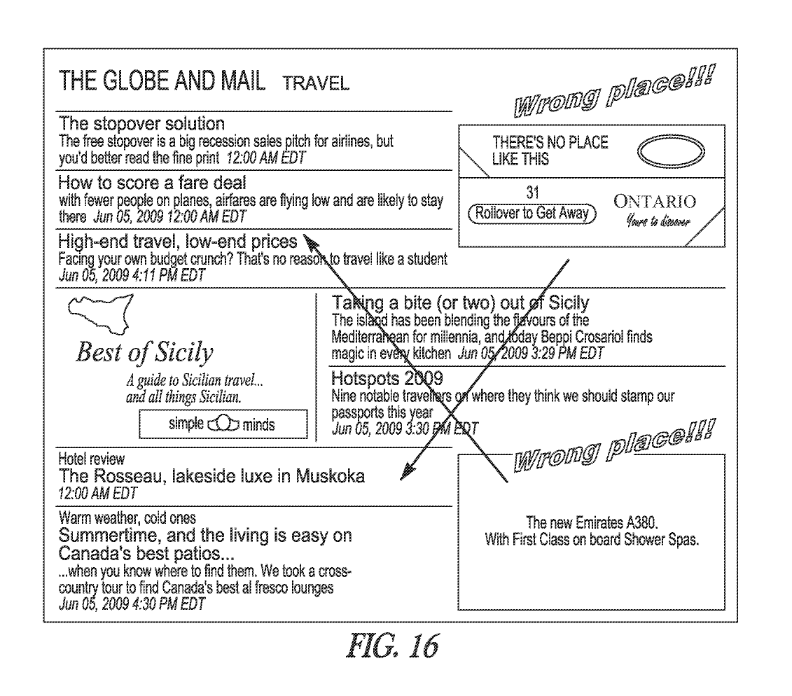

In the example shown in FIG. 16, a response is received for the Ad request described by reference to FIG. 15. The response contains three Ads, but does not contain a reference to the context. As a result, the Ads placed in Ad Spot #2 and Ad Spot #3 are inserted in the wrong place.

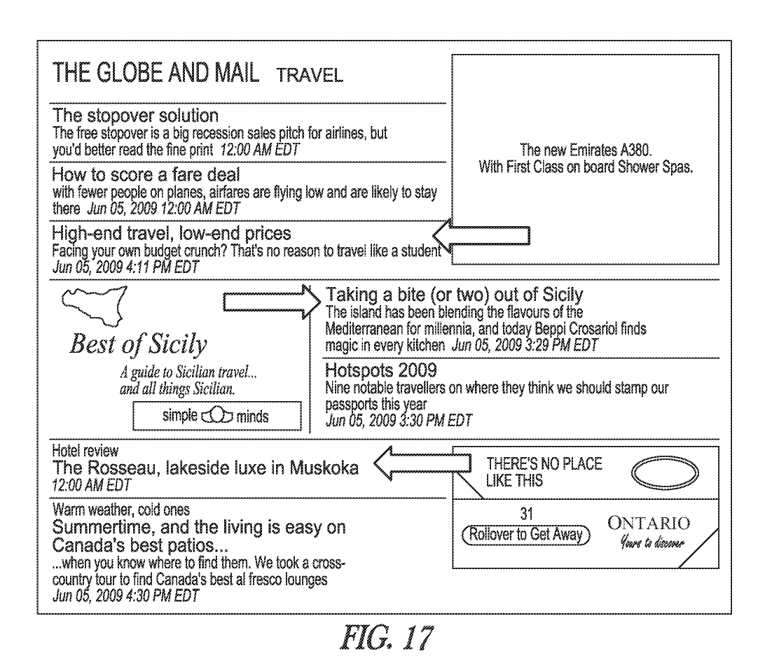

In the example shown in FIG. 17, a response is received for the Ad request described by reference to FIG. 15. In this example, the response contains a reference to the context so that the Ads can be positioned in the relevant spots. An example response may contain the following three Ads:

Ad 1 with reference to Context 2

Ad 2 with reference to Context 1

Ad 3 with reference to Context 3

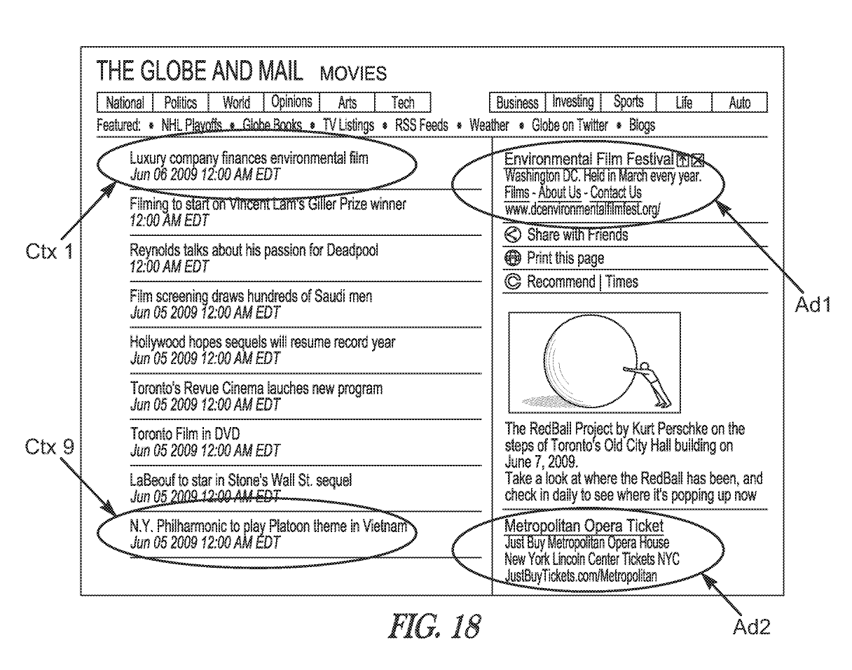

In the example shown in FIG. 18, an application may provide contextual data for nine RSS feed titles and display two Ads. In this example, the Ad placement may be dynamic (grid-based). As shown in FIG. 18, Ad 1 is placed in the same row as a relevant RSS title for Context 1 and Ad 2 is placed in the same row as a relevant RSS title for Context 9.

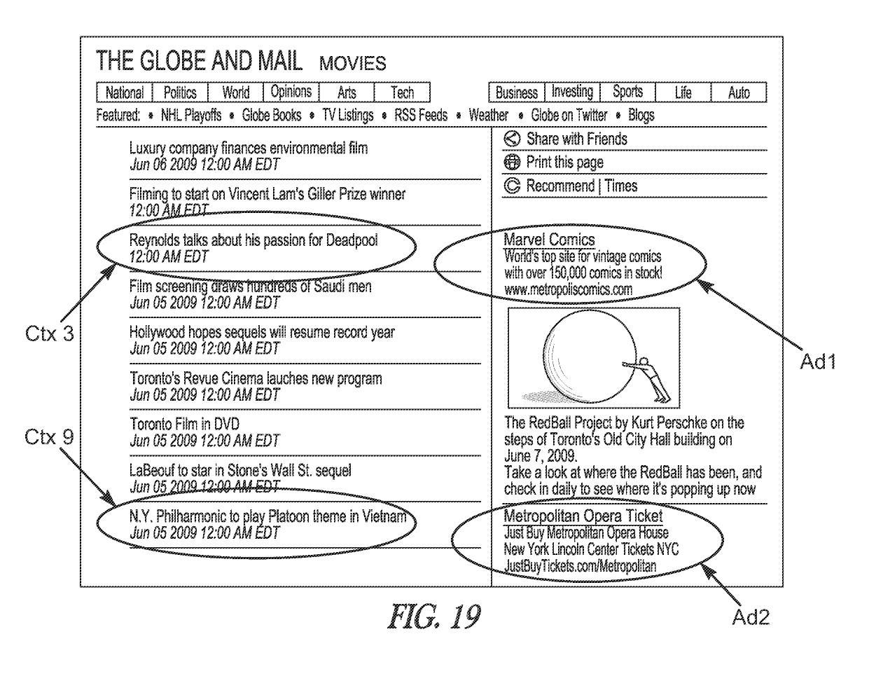

In the example shown in FIG. 19, an application may provide contextual data for the same nine RSS feed titles as in FIG. 18 and display two Ads. As shown in FIG. 19, Ad 1 now relates to Context 3 and is placed in the same row as the relevant RSS title for Context 3. Ad 2 again relates to Context 9 and is placed in the same row as the relevant RSS title for Context 9.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

Embodiments may be implemented in one or a combination of hardware, firmware and software. Embodiments may also be implemented as instructions stored on a computer-readable medium, which may be read and executed by at least one processor to perform the operations described herein. A computer-readable medium may be tangible or otherwise non-transitory and may include any mechanism for storing or transmitting information in a form readable by a machine (e.g., a computer). For example, a computer-readable medium may include read-only memory (ROM), random-access memory (RAM), magnetic disk storage media, optical storage media, flash-memory devices, and others.

What is claimed is:

1. A method comprising:
receiving, at an advertising server, an ad request including contextual data for at least one context;
selecting an ad by using the contextual data in the ad request; and
providing a response to the ad request, the response including the ad and a parameter identifying contextual data which was used to select the ad.

2. The method of claim 1 wherein the ad is specified by a payload of the response, or a reference in the response, or a combination of the payload and the reference.

3. The method of claim 1 wherein the contextual data corresponds to a plurality of contexts.

4. The method of claim 3 wherein contexts of the plurality are associated with identifiers.

5. The method of claim 4 wherein the parameter in the response is one or more of the identifiers.

6. The method of claim 5 wherein providing comprises:
omitting one identifier for one ad in the response when the one ad in the response was not selected relative to a context of the contextual data.

7. The method of claim 6 wherein providing further comprises:
including, in place of the one omitted identifier, metadata relevant to the one ad.

8. A method comprising:
providing an ad request to an advertising server, the ad request including contextual data; and
receiving a response from the advertising server, the response including an ad and a parameter identifying contextual data which was used to select the ad.

9. The method of claim 8 wherein the ad is specified by a payload of the response, or a reference in the response, or a combination of the payload and the reference.

10. The method of claim 8 wherein the contextual data contains a plurality of contexts.

11. The method of claim 10 wherein contexts of the plurality are associated with identifiers.

12. The method of claim 11 wherein the parameter in the response is one or more of the identifiers.

13. The method of claim 12 wherein one identifier for one ad in the response is omitted when the one ad in the response was not selected relative to a context of the contextual data.

14. The method of claim 13 wherein metadata relevant to the at least one ad is included in the response in place of the omitted one identifier.

15. A method comprising:
providing an ad request to an advertising engine, the ad request including contextual data for at least one context; and
receiving a response from the advertising engine, the response including an ad and a parameter identifying contextual data which was used to select the ad.

16. The method of claim 15 wherein the ad is specified by a payload of the response, or a reference in the response, or a combination of the payload and the reference.

17. The method of claim 15 wherein the contextual data contains a plurality of contexts.

18. The method of claim 17 wherein contexts of the plurality are associated with identifiers.

19. The method of claim 18 wherein the parameter in the response is one or more of the identifiers.

20. The method of claim 19 wherein
one identifier for one ad in the response is omitted when the one ad in the response was not selected relative to a context of the contextual data.

21. The method of claim 20 wherein metadata relevant to the at least one ad is included in the response in place of the omitted one identifier.
